(19) United States
(12) Patent Application Publication
(10) Pub. No.: US 2016/0086263 A1
(43) Pub. Date: Mar. 24, 2016

(54) SYSTEM AND METHOD FOR LOCATING AND ACCESSING ACCOUNT DATA TO VERIFY INCOME

(71) Applicant: Early Warning Services, LLC, Scottsdale, AZ (US)

(72) Inventors: Laura Weinflash, Scottsdale, AZ (US); Dawn Melvin, Scottsdale, AZ (US); Tom Mclaughlin, Phoenix, AZ (US); Janis E. Simm, Scottsdale, AZ (US); Christopher E. Swecker, Charlotte, NC (US); Lucius L. Lockwood, Phoenix, AZ (US); Robert Hill, Scottsdale, AZ (US); Aaron Batrim, Scottsdale, AZ (US); Nick Durkin, Scottsdale, AZ (US); Mary Hoover, Scottsdale, AZ (US)

(73) Assignee: Early Warning Services, LLC, Scottsdale, AZ (US)

(21) Appl. No.: 14/959,881

(22) Filed: Dec. 4, 2015

Related U.S. Application Data
(63) Continuation-in-part of application No. 13/213,975, filed on Aug. 19, 2011.
(60) Provisional application No. 61/499,599, filed on Jun. 21, 2011.

(51) Int. Cl. G06Q 40/02

(52) U.S. Cl. CPC G06Q 40/025

(57) ABSTRACT

Account data (e.g., account balance, account identifiers, account holder information and transaction data) for accounts at a plurality of financial institutions are stored at one or more databases within an account database system. The account data may be accessed in response to various requests (asset search request, as a verification request and income verification request). Transaction data for an account (such as ACH transaction messages) may be used to identify or verify income to an account holder, based on deposit/credits to the account.

### CROSS-REFERENCES TO RELATED APPLICATIONS

This application is a continuation-in-part of U.S. application Ser. No. 13/213,975, entitled SYSTEM AND METHOD FOR LOCATING AND ACCESSING ACCOUNT DATA, filed Aug. 19, 2011, which claims the benefit of priority to U.S. Provisional Application No. 61/499, 599, entitled SYSTEMS AND METHODS FOR FRAUD DETECTION/PREVENTION FOR A BENEFITS PROGRAM, filed Jun. 21, 2011, each of which is hereby incorporated by reference in its entirety for all purposes.

### BACKGROUND OF THE INVENTION

Account balance and other information for accounts held by an account owner are often needed by third parties for various reasons. For example, when applying for a mortgage, an applicant is typically required to provide information on all of the applicant's accounts to ensure there is sufficient cash attributable to the applicant (e.g., to use as a down payment). As another example, when applying for government benefits, such as supplemental security income (SSI) or other cash or services programs, a beneficiary's accounts must be located to ensure available assets have not been illegally transferred or do not otherwise exceed any qualification amount limits.

Similarly, third parties also often need to verify income. For example, a person applying for mortgage, consumer loan, credit card or other extension of credit may need to have a certain level of income to qualify (or to increase a credit line), and income stated by an applicant when applying for a loan or a credit line usually needs to be verified. Likewise, a person receiving government benefits may also need to have income (or lack of income) verified.

Searching for and verifying account balances and verifying income can be difficult and time consuming. For example, in the case of a mortgage application, where an applicant has a number of accounts at different banks or other institutions (as used herein, “institutions” may include any type of financial service organizations, such as banks, credit unions, third-party payment services such as PayPal or the like, online banking services, online virtual money account systems, investment firms, brokerages, credit card companies, loan companies, check cashing services, payday loan services, government institutions, or any other entity providing financial services or information), verifying account balances may involve sending written requests to a number of different institutions, and each institution conducting a manual look-up for each specified account. Further, the applicant may not have complete account numbers or may not remember or provide information on all accounts. Even if the applicant has account numbers, the applicant may not provide the correct bank name or ID (such as a routing and transit number) to enable convenient and timely verification. In other cases, when the applicant has all the necessary account information, and even if a current balance has been confirmed by a bank, that balance may not be legitimate. That is, an applicant may have received or borrowed funds from another person (such as a relative) to temporarily show an account balance larger than what is actually owned by the account holder, to fraudulently qualify for a mortgage or loan. Also, an loan/credit applicant may represent a certain level of income to qualify, but verifying income may require individually contacting (via phone or letter) one or more employers, and information received back from employers may not be timely or accurate.

In the case of an application for government benefits, an applicant may not disclose accounts (such as accounts where paychecks are deposited), or income reflected in those accounts that would result in disqualification under the benefits program, or may have made transfers out of accounts to conceal assets.

Further, government and law enforcement agencies may from time to time have need to execute and serve subpoenas or National Security Letters (“NSLs”) pursuant to 18 U.S.C. §2709 (or other applicable statutes) to institutions to gain access to financial accounts or information for individuals or entities (such as corporations) named in such subpoenas. However, it is time consuming and expensive for such government and law enforcement agencies to locate institutions that may have information regarding an individual or entity named in a subpoena, and the institutions waste significant resources and expense responding to such subpoenas especially when there is no account or financial information for the named individual or entity that is accessible by the particular institution. The problem is magnified by the current approach of law enforcement to take a “shotgun” approach by delivering subpoenas or NSLs to a large number of major institutions in an attempt to find any applicable accounts for a person or entity of investigatory interest.

Thus, there is a need for systems and methods to locate, verify and/or access account information, especially for accounts that are maintained across a number of different institutions.

### BRIEF SUMMARY OF THE INVENTION

Embodiments of the present invention provide systems and methods for locating and accessing assets, such as accounts. For purposes of the present disclosure, accounts may include, but are not limited to, deposit accounts such as checking, savings, CDs, money market accounts in the United States, or International accounts. Accounts may also include (i) reward or loyalty accounts providing merchant reward points, such as in the exemplary case of retail sales; (ii) online financial accounts such as PayPal accounts; (iii) online gaming such as Farmville or SecondLife; or (iv) frequent flyer programs or stored value accounts. Further, accounts may include credit or loan accounts, credit card accounts, debit accounts, prepaid accounts, or any account regarding any desired type of financial information.

In one embodiment, a system and method is provided for locating an account. The system and method provides a database for storing account data for accounts maintained at a plurality of institutions. The account data for each account includes at least a personal identifier for an account holder. A request to locate an account is received, with the request including a submitted personal identifier. The account is located by matching the submitted personal identifier to the personal identifier stored in the database, and at least some of the account data for the located account is retrieved.

In another embodiment, a system and method is provided for locating and accessing an account of an account holder without having to contact one or more institutions where the account might be maintained. The system and method provides a database populated with account data for a plurality of accounts from a plurality of institutions maintaining the accounts. Account data is initially transferred from each of the institutions. The account data represents a plurality of account characteristics associated with each of the accounts. The account characteristics comprise an account identifier assigned to each account by the maintaining institution, a personal identifier for the account holder that is assigned by an entity independently of the institutions, and a balance of funds in the account. Updated account data is also periodically transferred from each of the institutions. The account data is stored in the database. A personal identifier (such as a social security number) for an account holder may be used to locate and retrieve at least some of the account data.

In yet another embodiment, once an account has been located and account data (such as transaction information) accessed, income of the account owner can be identified or verified based on analysis of transactions (that reflect periodic income deposited into the account). In related embodiments, two databases are provided, with a first database storing account ownership data (identifying information for each of the accounts and account holders) and a second database storing transaction data, such as ACH transaction data, posted to the accounts. A personal identifier is provided in order to retrieve from the first database an account identifier associated with personal identifier. The retrieved account identifier is then used to retrieve from the second database ACH transaction data posted to the account, which can in turn be evaluated to identify income reflected in deposits/credits posted to the account.

In still yet another embodiment, a government or law enforcement agency may provide one or more personal identifier(s) corresponding to an individual or an entity named in a subpoena (or an instrument such as a National Security Letter or Writ of Execution) for financial or accounting records access, and the provided personal identifier(s) is/are used to determine which institutions, if any, have account or financial information for the individual or an entity named in the subpoena. If one or more of such institutions are found to have such account or financial information for the individual or an entity named in the subpoena, the names of the matching institutions are provided to the government or law enforcement agency with sufficient information (account number or identification information, for example) so that the subpoena may be efficiently served on the one or more matching institutions. If no matching institutions are found, indicia showing no match found may be returned to the government or law enforcement agency. Although a described embodiment provides the account identification information for subpoenas to government or law enforcement agencies, it is understood by those of skill in the art that a service could be provided to non-government entities or persons to locate bank accounts corresponding to the identified parties. As described more completely below, additional embodiments may perform analysis to provide additional information to the querying entity.

### BRIEF DESCRIPTION OF THE DRAWINGS

FIG. 1 is a block diagram of a system for locating and accessing account information in accordance with embodiments of the invention.

FIG. 2 illustrates exemplary data provided to and stored in the database system of FIG. 1.

FIG. 3 illustrates fields in a typical ACH transaction entry that may be used for income detection or verification in the system of FIG. 1.

FIGS. 4-6 are flow diagrams illustrating various processes implemented within the system of FIG. 1, for locating and accessing account data.

FIG. 7 is a block diagram of one suitable scoring model and process for use in one embodiment of the invention.

FIG. 8 is a flow diagram illustrating a process implemented at the system of FIG. 1, for detecting or verifying income based on transactions posted at a located account.

FIG. 9 is a flow diagram illustrating a process implemented within the system of FIG. 1 in accordance with an alternative embodiment, for issuing subpoenas in response to locating and accessing account data.

FIG. 10 is a block diagram of a computer system at which various devices, systems, and processes described in conjunction with FIGS. 1-9 may be implemented.

### DETAILED DESCRIPTION OF THE INVENTION

Described embodiments of the present invention provide means for enabling assets (such as financial accounts owned by an account holder) to be located and accessed, even when maintained at a number of different institutions. In some embodiments, accounts are located using a personal identifier associated with the account holder, rather than an account number. In one specific embodiment, the personal identifier is a social security number (SSN).

In certain described embodiments, a system for locating assets may receive different types of requests to locate assets (such as financial accounts). One such request may be an asset search request. Another request may be an asset verification request. A third request may be an income verification request, based on locating accounts that may reflect income (e.g., certain kinds of deposits) made to the located account.

Briefly, as examples, an asset search request might be used by a government entity to locate accounts of a person applying for welfare benefits or some other form of government assistance. Government programs providing benefits (particularly welfare benefits) often have criteria that permit applicants/beneficiaries to qualify only as long as their assets (such as checking, savings and other financial accounts) have balances below a specified threshold. As an example, in many states, a beneficiary must have no more than $2000 in assets in order to qualify for Medicaid nursing home benefits. The systems and methods described herein permit an asset search for any accounts held by the beneficiary in order to confirm that balances in accounts held by the beneficiary are in fact below the required threshold. In other embodiments, transaction data in an identified account may be evaluated to determine or verify benefits eligibility. For example, where benefits eligibility is based on or related to income, a system and method could additionally provide account data relevant to the risk that a beneficiary is receiving income (e.g., deposited into an account) that would make the beneficiary ineligible for benefits. As a more specific example, in the case of unemployment insurance benefits paid by a government agency, transaction data in an identified account could be evaluated to provide risk scores and/or indicators pertaining to whether there might be employment income deposited to an account that would make the account holder ineligible for receiving or continuing to receive unemployment benefits. Data reflecting the likelihood of employment income could be based on data provided for ACH transactions posted to the account (e.g., ACH data indicating payroll deposits), or for non-ACH deposits (e.g., check deposits), based on the payor name or account, the check amount, or other check deposit information (e.g., by comparing that information to prior employment data provided by the beneficiary or by comparing that information to transaction patterns or history). In some embodiments, the periodicity or timing of deposit transactions might be relevant and could be evaluated.

As yet another example, transaction data at located accounts could be used to verify income that has been claimed or stated by a person, such an applicant for a loan (e.g., a mortgage loan). As described above, deposits/credits in the form of ACH transactions (and, in some cases, non-ACH credits/deposits) may be identified that reflect possible or likely income. Such income is reported back to an requester (e.g., a bank where the applicant submitted a loan application). The reported income could be evaluated by the requester for consistency with income stated by the loan applicant. In some embodiments, scores relating to the reported income may also be provided to the requester. For example, one score may provide a likelihood that the deposit/credits reflects actual income. Another score may provide a likelihood of such income occurring in the future (based on the nature or patterns of the identified deposits/credits. Yet another score may reflect a risk associated with located accounts (e.g., a risk of fraud), based on suspicious transactions at the account or other circumstances or personal data associated with the account or the account holder.

An asset verification request, on the other hand, might be used by an entity (such as a mortgage company) to verify account balances. For example, a mortgage applicant may state that the applicant has sufficient funds saved in one or more accounts to make a down payment (or sufficient funds saved to supplement income as needed to make mortgage payments). In this example, a mortgage company needs to verify that balances in the applicant's accounts are adequate to meet the applicant's financial needs after the mortgage has been granted.

Embodiments of the present invention support alternative asset/income search and verification queries or requests. For example, systems and methods as described herein may be used in various situations where account information (such as balances or deposits reflecting income) may be needed, such as to qualify or comply with certain government programs, to obtain consumer/commercial loans, or to initiate legal or other actions. These situations include (but are not limited to) programs involving cash or noncash welfare payments, health care assistance, Supplemental Nutrition Assistance Program (SNAP), Supplemental Security Income (SSI), child support requests (e.g., confirming financial means or needs), Housing Subsidies, Earned Income Tax Credits (EITC), corporate audit verifications, small business loans, student loans, mortgage loans, credit card applications, student financial assistance, credit checks, and delinquent tax collections.

Other embodiments may support asset/income search and verification requests for various kinds of accounts or account information beyond those maintained at financial institutions. For example, government agencies may contribute benefits data, including details relating to those benefits and relating to the beneficiary, such as name, address, social security number (SSN), date of birth, employer (if any), date benefits applied for, type or amount of benefits, date benefits began, agency or agency location, and so forth. As should be appreciated, such information (particularly when accessible by using a personal identifier or SSN of the beneficiary), can be used, e.g., to identify and assess the risk of fraud when processing a beneficiary's request for benefits.

In addition, systems and methods of the present invention permit account information from a large number of banking and other institutions as well as from government agencies to be stored in a single database system (that may include multiple databases) so that accounts across all of those institutions or agencies may be searched or verified with one request. Not only does this eliminate the need for contacting multiple institutions and agencies, but it also permits the data from individual accounts (or multiple accounts) to be analyzed for risk-related factors (e.g., in the case of mortgage applications, factors indicating savings patterns, suspicious deposits, deposits reflecting possible income, and possible links to known fraudsters/con artists; and in the case of government benefits, factors indicating suspicious transfers to third parties or benefits received across multiple jurisdictions or agencies). In some embodiments, search or verification requests may be batched and sent daily. In other embodiments, an individual search or verification request can be sent electronically (on-line and in real-time), and an immediate response can be returned by the system. In one implementation, the located account information sent in the response can be immediately reviewed, perhaps in the presence of the applicant (e.g., while a mortgage applicant is in the presence of a mortgage officer), thus permitting the applicant to explain discrepancies and provide further information that can be used to refine subsequent requests, if appropriate. Such an exchange of information in real time may significantly reduce the time and cost of mortgage qualification, cash and services benefits applications and other processes requiring a search or verification of accounts.

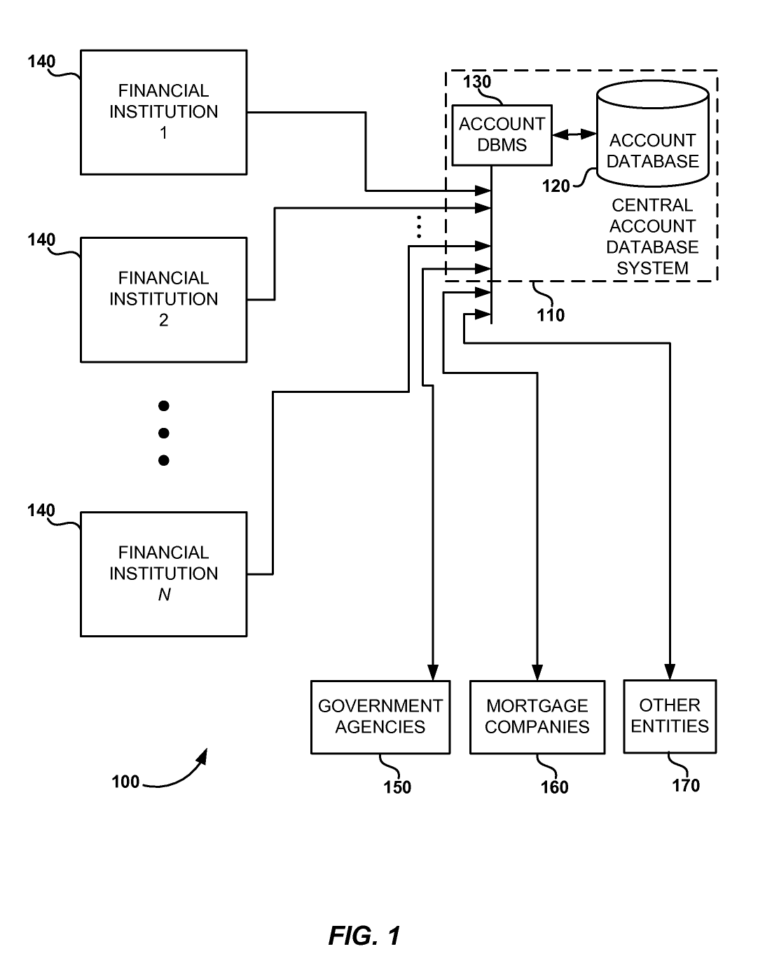

Turning now to FIG. 1, there is shown an exemplary system 100 for locating and accessing account information. The account information is stored and processed at a central account database system 110 having database device(s) 120 for storing account information and an account database management system (DBMS) 130 for managing the data in database 120 (e.g., the DBMS stores, retrieves, arranges, sorts and processes the data in the database). As illustrated, the data used to populate the database 120 is obtained from a number of financial institutions 140. In addition, requests to access the account data stored in database system 110 may be received from government agencies 150 (e.g., to establish qualification for benefits), from mortgage companies 160 (e.g., to verify account balances/income) and from other entities 170 (e.g., needing to locate and access account data for various reasons, such as creditworthiness, ability to supply funds, or asset/income verification).

The financial institutions 140 maintain financial accounts, and include banks, savings and loan associations, investment firms and similar institutions. The accounts for which data is provided may include checking accounts, savings accounts, certificates of deposit, brokerage accounts, money market accounts, and other financial accounts (in the United States or elsewhere). Accounts may also include (i) reward or loyalty accounts providing merchant reward points, such as in the exemplary case of retail sales; (ii) online financial accounts; (iii) online gaming accounts; or (iv) frequent flyer programs or stored value accounts. Further, accounts may include credit or loan accounts, credit card accounts, debit accounts, prepaid accounts, or any account regarding any desired type of financial information.

It should be appreciated that, while the embodiment illustrated in FIG. 1 assumes financial institutions will contribute data, and that government agencies, mortgage companies and other entities will access the data, in some cases the financial institutions 140 may also access account data in system 110 (e.g., as part of a loan application) and government agencies 150, mortgage companies 160 and other entities 170 may contribute account data (e.g., benefits accounts and mortgage accounts). Thus, in their broadest sense, financial institutions 140 may represent any kind of institution or other entity maintaining an account or asset (financial or otherwise), and government agencies 150, mortgage companies 160 and other entities 170 may represent any kind of entity (governmental, commercial or otherwise) wanting to locate and/or verify accounts or assets that are maintained at various institutions.

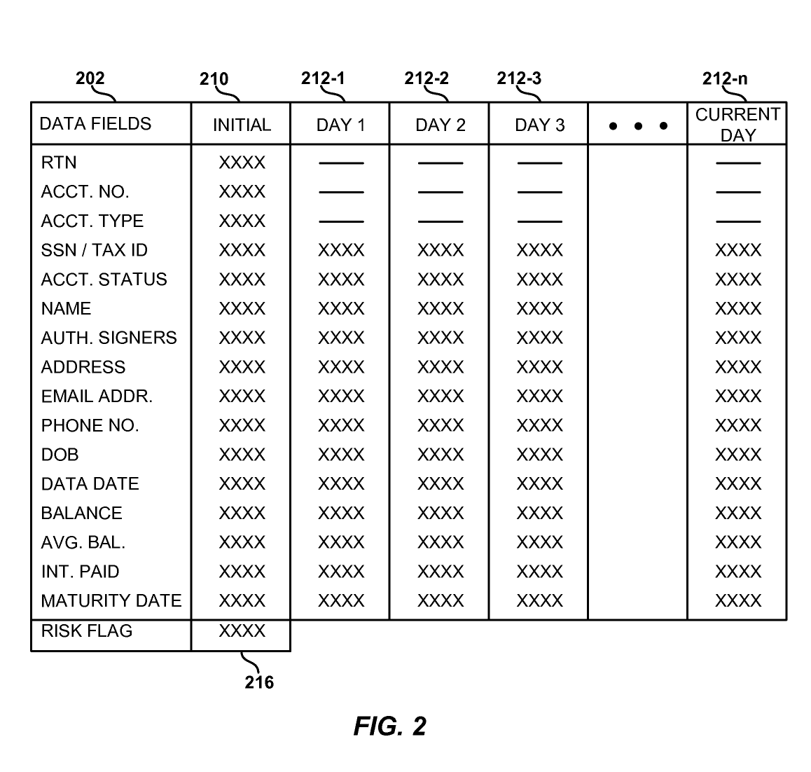

FIG. 2 illustrates exemplary data provided to (and stored in) the database system 110 by each of the financial institutions 140. In this particular example, the data comprises account data for a bank account, and thus includes the following data fields (collectively designated as 202 in FIG. 2):

Routing and Transit Number (RTN)

Account Number

Account Type (e.g., checking , savings, certificate of deposit, investment account)

Social Security Number (SSN)/Tax ID Number

Account Status (open/present, closed, deceased, non-sufficient funds, etc.)

Name of Account Holder(s)

Authorized Signor(s) of Account

Address(es) of Account Holder (e.g. a physical mailing address)

Email Address(es) of Account Holder

Phone Number

Date of Birth (DOB) of Account holder

Data date (date of receipt by system 110)

Current Balance

Average Balance (e.g., average balance over the past 30 days)

Interest Paid

Maturity Date (e.g., maturity date for a certificate of deposit)

As should be appreciated, FIG. 2 shows data for only one account, and in practice there would be many accounts from many institutions stored in database system 110. Further, while not illustrated in FIG. 2, in certain embodiments transaction data (such as credits/debits) posted to each account may also be provided to (and stored in) the database system 110, e.g., for purposes of detecting possible income to the account holder (as will be described in greater detail later). In one embodiment, the database system 110 includes at least two separate databases or database storage systems, namely, a first database (account ownership database) for storing account information such as that described above in connection with FIG. 2, and a second database (ACH database) storing transaction data (e.g., ACH transaction data) posted to each of the accounts for which account information is stored in the first database. For example, the first database may be accessed with a personal identifier (such as a social security number) provided by an requester, and an account identifier (account number and, if necessary to identify the financial institution, an RTN) associated with the personal identifier is returned and used to access ACH transactions posted to the account associated with the account number.

As seen in FIG. 2, the data includes an initial transfer 210 for each of the data fields (current and historical information at the time of the initial transfer), and subsequent periodic transfers 212-l through 212-n for most of the same data fields (to keep the data updated). In FIG. 2, the illustrated periodic data transfers 212-l through 212-n are each transferred and stored daily (Day 1, Day 2, Day 3, etc., up to the current day). Such a frequent updating is generally preferred, although is some embodiments and applications a less frequent updating might be acceptable. The updated data fields are illustrated as including the same data as the initial transfer, other than the RTN, Account Number and Account Type fields, since it is assumed, for purposes of the described embodiment, that these three data fields will remain unchanged over the life of the account.

Also, FIG. 2 shows each updated daily transfer of data (212-l through 212-n) having all fields 202 in database system 110 populated with data (other than RTN, Account Number and Account Type). However, in practice, much of that data will not change between transfers, and so database system 110 may be managed so that only the changed data in a daily transfer will be stored (in such case, especially if updates are daily, many of the data fields illustrated in FIG. 2, as well as duplicates of transaction data, would in fact not be populated in order to efficiently manage storage space and minimize unnecessary data processing). This filtering of unnecessary data could be implemented in one embodiment by database system 110 being programmed to review data fields as they are received from the financial institutions 140 and to remove data that has not changed since the day before. In another embodiment, the financial institutions 140 may have systems on-site and programmed to remove unchanged data before it is transmitted.

It should be appreciated that, since the data stored in database system 110 is likely to be extensive for any given account, the account data could be processed in a number of ways by system 110, in addition to being available to a requester making an account search or verification request. For example, the data could be processed to provide balance information in various forms (e.g., a single, current 30 day average balance, or average balances over 6 months, over 1 year or longer). The needs of the requester can thus be met by processing data in a way that is useful to the requester (e.g., a governmental entity is likely to need different information than a mortgage company). In a response the data associated with any account can be filtered, processed and stored in a way to provide only the information on the account that is most useful to the requester.

In addition, and as will be described in more detailed later, the data associated with an account can be analyzed (and, in some cases, compared to data from other, external sources) to provide risk scores or other risk/probability data pertinent to the request. For example, the database system 110 may respond to a mortgage company request with not only basic account information (current status, current account balance, and average balance), but also with alerts and flags if critical data has recently changed (new signers, new account holder names, significant changes in balances, etc.). Also, patterns for deposits and withdrawals (e.g., as reflected in daily balances, or by individual transactions) can indicate if the account holder is a consistently good saver, or has relied on a single or a few large deposits in order to reach the current balance. Transaction data stored in accordance with some embodiments can also be evaluated for indicating possible income to the account holder. If the entity managing the database system 110 provides risk-related data, then data stored in the database could also include a risk marker 216 (stored in a “Risk Flag” field as seen in FIG. 2) that indicates risk factors have been identified for the account. The risk marker could be as simple as a “yes” or “no,” and in other embodiments could be a code to indicate whether the risk is relevant to specific categories of requesters, such a government benefits program, a mortgage company, a creditor, or some other request category. It should be appreciated that some factors (e.g., recent patterns of transfers out) would be relevant to a request from a government benefits program, and the same factors may have little or no relevance to a mortgage company. In embodiments where the system has collected risk-related data (in addition to the risk marker itself), such data could be stored in a separate table of data (to be described later), and would only be accessed if the risk is relevant to the purpose of the request.

While FIG. 1 shows the data contributed to database system 110 coming only from the financial institutions 140, as will be described later, in some embodiments the system 100 may have other sources of data (not shown) connected to and providing data to database system 110. Such other sources would permit assessment of risk of fraud that may arise from activity or circumstances other than transactions posted to accounts at the institutions 140. Also, in some embodiments, a separate fraud system (not shown) might analyze data from accounts for risk. As described earlier, data associated with the risk-related data may further reflect the degree of likelihood/probability that a deposit/credits to the account reflect actual income to the account holder.

As mentioned earlier, in some embodiments transaction data for individual accounts may be stored and evaluated at the database system 110 (in addition to the data illustrated FIG. 2) for purposes of detecting or verifying income to the account holder. The data may come from transactions representing both ACH and non-ACH transactions. ACH transactions are particularly useful in detecting employment income because ACH transaction files often provide more detail than paper check transaction/transit item files. As one example, ACH entries have standardized data fields with the name or ID of the originator (e.g., the name of the payor in a credit/deposit transaction), SEC codes, and text entry descriptions prepared and inserted by the originator.

In one embodiment, as briefly described earlier, account information (such as the data illustrated in FIG. 2) may be stored in one database within system 110 and transaction data for each of the accounts may be stored in a second, separate database, with transaction data in the second database accessed by using an account number or identifier retrieved from the first database, e.g., in response to a personal identifier provided by a requester

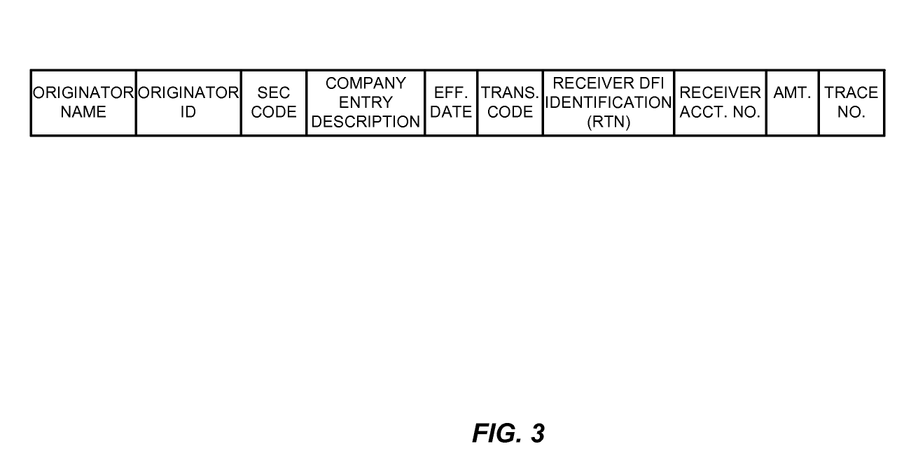

FIG. 3 illustrates some of the fields present in a typical ACH transaction entry/message, as sent from an originator's bank to a receiver's bank (e.g., the receiver's bank is where money may be deposited). As seen, the entry may include the name of the originator (in the case of a deposit, the payor), a unique ID associated with the originator, a standard entry class (SEC) code (identifying one of various general classes of ACH transactions that can be processed between banks), an originator entry description (typically, a few words of text chosen by the originator and describing the transaction), an effective date, a transaction code (e.g., identifying the transaction as a debit or credit), an RDFI identification (also known as the routing and transit number or RTN of the receiver's bank), the account number of the receiver/payee, the transaction amount, and a unique trace number for the transaction. Various embodiments of the present invention may use some or all of the fields to achieve a desired result.

The name of the payor can be useful by comparing it to a list of likely employers. Also, among possible SEC codes is “PPD,” which designates a “Prearranged Payment and Deposit Entry.” Such a code is typically used for a recurring entry for a direct deposit of payroll (or recurring payments out of the account for bills), and can thus be used for identifying a recurring transaction. The “Company Entry Description” is text entered by the originator, and it is common for employers to use certain key words such as “payroll” in such text when the transaction is an electronic deposit of a paycheck. As should be appreciated, the review of these fields (individually or together) for a specific transaction will often indicate the type of income attributable to the transaction (payroll/employment, private pension, public pension/benefit (e.g., from social security), investment income (e.g., from an investment company/brokerage), which may be useful for and reported to the requester).

However, as also mentioned earlier, transactions other than ACH transactions may yield useful data in evaluating whether an account holder is receiving income. For example, data associated with the deposit of checks may include the name of the payor, the amount of the check, and the account from which it is drawn (e.g., for comparison to lists of accounts known to be used or likely to be used for payroll).

As also mentioned earlier, account history can establish patterns of transactions and deposits, and can yield data for use in evaluating recent transactions. One strong indicator of employment income is a recurring deposit, since employment income is typically periodic. The amount of net pay will often not change much or at all between pay periods, and if it does change, the change can be attributable to predictable factors, such as annual raises, changes in federal and local tax rates, changes in standard exemptions due to family/personal circumstances, predictable changes in deductions attributable to healthcare and other insurance premiums, sales incentives varying by demand or time of year, and so forth. Also, account history can be used to assess fraud risk in addition to the probability that deposits represent actual income. For example, transactions over a period of time (and posted to multiple accounts) can evidence attempts to conceal assets (holding money in accounts not identified to the agency by the claimant), and transaction patterns of larger amounts being broken into smaller transaction amounts (over multiple accounts) can evidence money laundering. All these patterns and characteristics can be used in assessing the risk of fraud.

In addition, in a specific embodiment involving a person applying for unemployment benefits, the person may be asked to disclose (as part of the application for benefits) sources of income or deposits not attributable to employment income, and that would not disqualify that person from receiving benefits. Examples might be regular non-employment income received from savings, investments and annuities, paychecks received by other family members that might be deposited to an account jointly owned with the claimant, and expense reimbursement amounts or severance pay expected from a past employer (e.g., that might be deposited after termination). All this information can be taken into account in evaluating transactions to determine whether an individual transaction is likely to reflect relevant employment income. In other embodiments, any income (whether from employment or other sources) would be relevant and considered in identifying/verifying income.

Account history and recurring payments can be evaluated in a number of different ways. As an example, an account holder's occupation might result in paychecks of varying amounts (e.g., because the pay was wholly or partly based on commissions). Rather than relying on indicators of near constant income, account history could be considered to determine the timing or frequency of past deposits. If the account holder's account continues to show deposits of the same frequency or on or near the same days of the month as in the past for paychecks (even though varying in amount), such deposits might reflect continuing employment income.

In one embodiment, the data resulting from the analysis of transactions in any account is provided to a scoring model (e.g., implemented by programming within database system 110) which uses statistical or other analysis to determine the likelihood that a deposit reflects income. The scoring model could use a plurality of weighting/risk factors. The actual weighting factors may differ based on fine-tuning and honing of the scoring model, and might change over time based on experience. Different requesters/inquirers may assign different weights to different factors, and in some cases the inquirer using the risk data will choose different weights depending on its own experiences or its risk tolerance. Data is collected and then statistically reviewed to identify specific transactions or patterns of transactions which predict income probability. For example, the design of the model could be based on analysis of large numbers of past transactions (involving many account holders), and the characteristics of such transactions. Based on that empirical and experiential data, predictive data can be generated as to how any given past ACH transactions (or traditional paper check transactions) and their patterns might predict the nature of future similar deposit transactions, including predicting the likelihood that such transactions (and the income that they reflect) will continue for at least some period of time into the future. This may be particularly useful when an income verification is requested in response to an application for a loan or credit, where the loan or credit may extend well into the future. The predictive characteristics are identified and then built into a model. In alternative embodiments of the present invention, neural models or rules models may be used instead of statistical models.

The scoring model might yield a score indicating risk or likelihood of relevant income (for example, from 1-100, with “1” indicating a very low likelihood that a deposits reflects periodic income, and “100” indicating a very high likelihood that there is periodic income). As mentioned earlier, in a response to a query, the score could be accompanied by factors or the circumstances that gave rise to the score, such as continued recurring payments, payments from a known employer, and payments from another source that is likely to pay income. Such information is provided to the inquirer with the level of detail that may be needed to investigate and determine whether the income is relevant or not to the inquirer. For example, the score could accompany details for specific transactions (including amounts) that reflect possible income and that gave rise to the score.

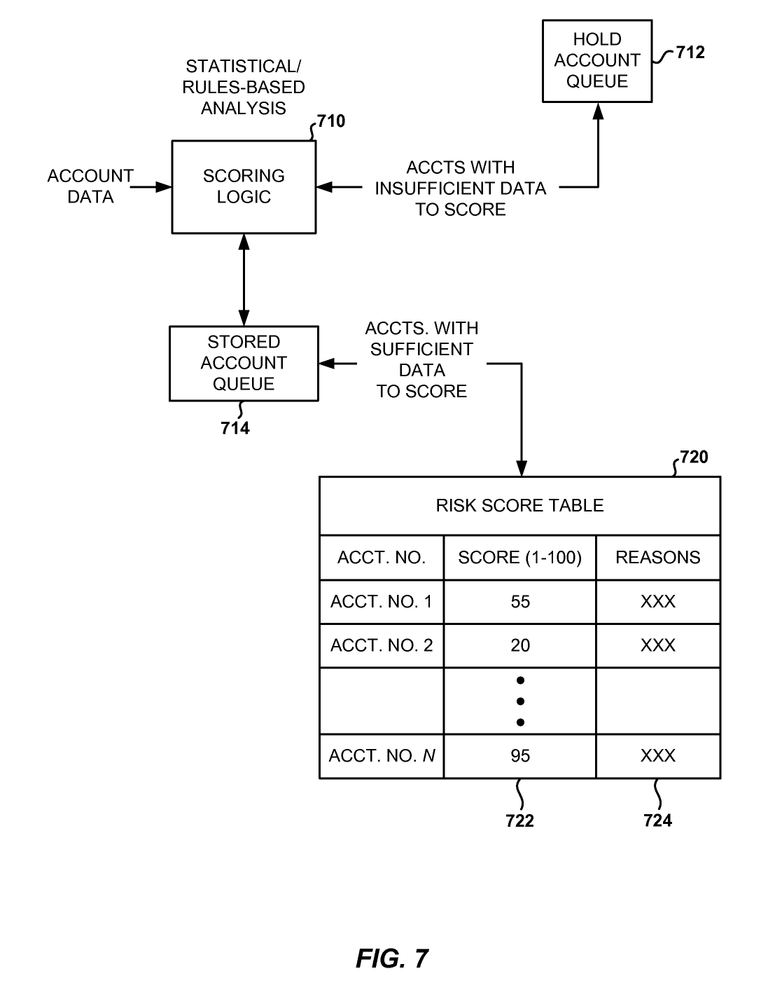

A specific scoring model that could be used in certain embodiments will be described later in conjunction with FIG. 7.

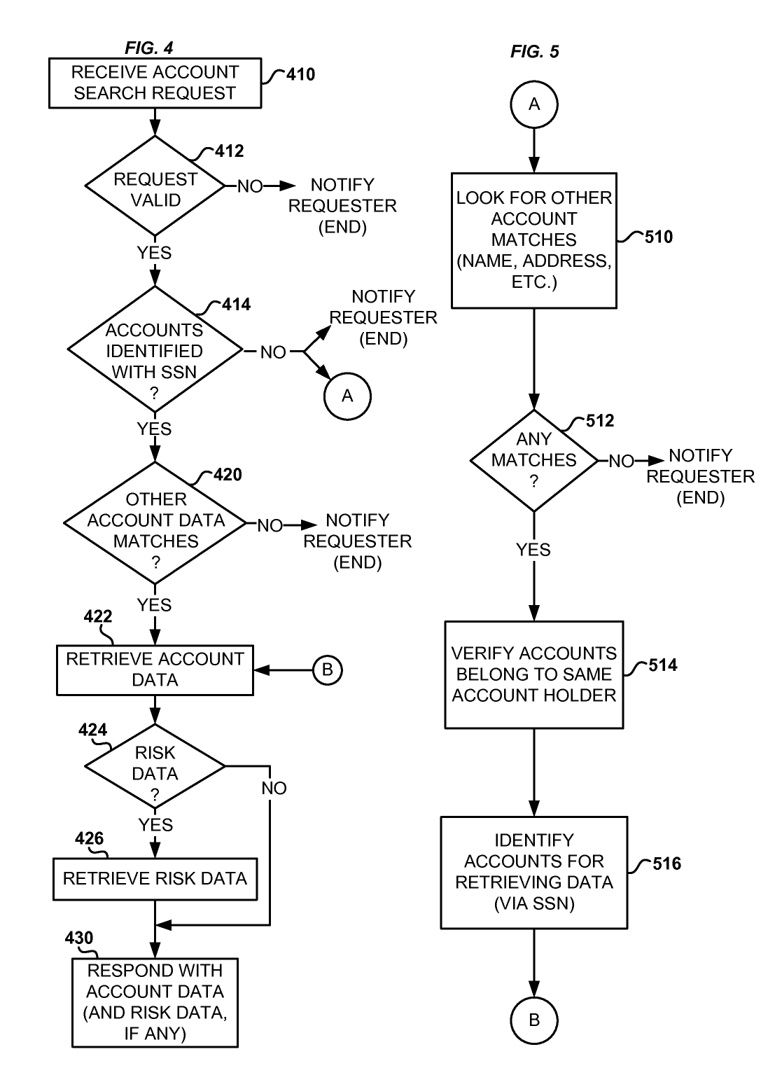

FIGS. 4, 5 and 6 illustrate processes for responding to certain requests received at the database system 110. Before proceeding with descriptions of such Figures, it should be noted that a request to the system 110 may have a standard format and include information pertinent to the person (for whom the account data is sought), such as account holder SSN, name, address, and bank name(s) and account numbers (if any). However, information needed to identify any accounts for the person could be minimal and, in one embodiment, might only be an SSN. For example, in the case of an account search request (e.g., by a government agency doing a search for accounts), the SSN may be the only identifier provided and used to locate accounts. Other relevant data can be provided, if desired, to provide more accuracy and confirm matches (name, address, and even bank account numbers—if supplied by the person), and generally more information will be returned and its accuracy improved when more personal information is provided. In the case of an account or income verification request (e.g., by a mortgage company wanting to verify information supplied by an applicant), account numbers would typically be provided (for redundancy) as identifiers in addition to an SSN, to make sure that any account identified by an applicant is considered. But even in that example, the system 110 could process and return account information based on a social security number. However, with either type of request, it should be appreciated that in some embodiments the requester may only provide a social security number as an identifier, and information can be returned by system 100 based only on that identifier and not relying on account numbers or other data concerning the account holder.

Turning now to FIG. 4, there is illustrated a process within database system 110 relating to a request for an account search (e.g., locating for a government agency any account at any institution belonging to a person that is the subject of the search) is received by system 110 (step 410). The system determines if the request is valid (step 412). Such a determination could be based on several possible factors, such as whether the requester is authorized (e.g., the requester has, in advance, been properly authorized as an entity or individual), whether the request has been properly formatted (e.g., a personal identifier, such as a provided SSN, has the correct number of digits or is recognized as a valid SSN), and whether the device transmitting the request is recognized (e.g., from previous transactions or has been authorized in advance by the requester). If the request is not valid, the requester is notified (and the request is not processed further). If the request is valid, the system next determines whether there is an account in the database system 110 that matches the provided personal identifier (step 414). If the personal identifier does not identify any account, the requester is notified and the process ends (as indicated in FIG. 4). Alternatively, other steps can be taken (point “A” in the drawings) to identify accounts without using a social security number (such steps will be described shortly in conjunction with FIG. 5).

If accounts are identified with the provided personal identifier, the system looks for matches with other data (if any) provided by the requester (step 420). For example, a name or address provided in the request is compared to the data stored in system 110 for the identified account, and if there is no match the requester is notified and the search may end (at least temporarily). Alternatively, the process could continue, but with the understanding that the account data may not be relevant to the person that is the subject of the request. If the data matches at step 420, then the data for the identified account is retrieved, step 422. If risk data is also to be provided (if available and requested, step 424), then the risk data is retrieved (step 426) and the retrieved data is provided to the requester as part of the response (step 430).

As mentioned above, in some cases, even if an account is not identified with a personal identifier such as an SSN (step 414), the system 110 can be programmed to locate accounts using other personal information of the person in question. This is illustrated in FIG. 5, where the system 100 first looks for other matches of personal information (e.g., names, addresses, phone numbers), and if there is match (step 512), the system may also analyze the match to verify that the information is for same account holder (step 514). As an example, this last step can be based on the amount of information matched, so that with two or more pieces of personal information being the same (both name and address for an account are the same as the name and address in the request) a match is indicated. In this example, if there is there is no match, the system 110 notifies the requester and the search ends. As an additional step, the system 110 may also further review any account where a match is made and verified at steps 512 and 514, identify the personal identifier such as an SSN for that verified account, and then also identify any other accounts in the database (at any institution) having the same personal identifier as the verified account (step 516). This process then returns to the process in FIG. 4, with any retrieved data provided back to the requester.

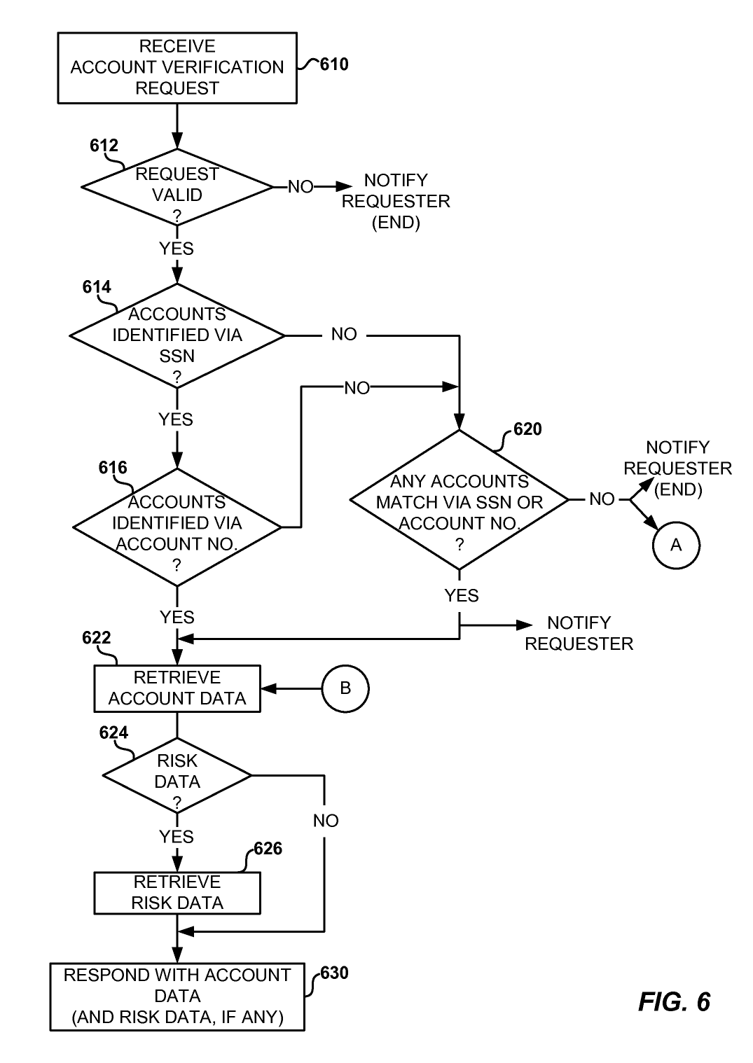

FIG. 6 illustrates a process similar to that of FIG. 4, but rather than an account search request, this process is used to respond to an account verification request (e.g., from a mortgage company). An account verification request is received by the system 110 (step 610) and the system determines if the request is valid (step 612). The system then determines if any accounts stored in the system are identified by the provided personal identifier such as an SSN, step 614. Since many account verification requests will also include account numbers provided by an applicant, the system determines if any accounts are identified by provided account numbers (step 616). The accounts that are identified (either at step 614 or step 616) are retrieved (step 622).

The system notifies the requester as to the nature of the matches (step 620). If there is no match of any accounts (no match of either the personal identifier or the account number), the requester is so notified and the process may end with that notification at step 620 (as indicated in FIG. 6). Alternatively, additional steps can be taken (point “A” in the drawings) to identify accounts (such additional steps are shown in, and were earlier described in conjunction with, FIG. 5). If, at step 620, there has been a match of only one of the personal identifier or account number, the requester is so notified (as to what identifier or information resulted in the match) and the process continues to the earlier described step 622 (account data for the identified account is retrieved).

If risk data is also to be provided (if available and requested, step 624), then the risk data is retrieved (step 626) and the retrieved data is provided to the requester as part of the response (step 630).

While FIGS. 4, 5 and 6 illustrate the search or verification process ending when no accounts are identified or found within system 110 (e.g., at steps 414, 512, and 620), it should be appreciated that other methods could be employed to respond to a search or verification request, in the event of an account not being found within system 110. For example, in one embodiment, when a requester provides account numbers and one or more of those account numbers are not found in the system 110, the system 110 could be configured to forward those account numbers to the institution(s) where they are maintained (e.g., using an RTN or bank name provided with the request), and then to respond to the requestor with any information supplied directly by the institution. In some cases, information supplied directly by the financial institution may supplement the account data retrieved from database 120 and, in those cases, both the information from the financial institution and account data retrieved from database may be provided in a response to the requestor (e.g., at steps 430 and 630). The methods just described could be accomplished automatically (on a batched basis or in real-time) in response an account number not being found in system 110 or, alternatively, could be accomplished with the assistance of personnel involved in operating the system 110. In yet another embodiment, the system 110 could be electronically linked to the systems at various financial institutions 140 and configured to remotely search account databases at those institutions, so that as the system 110 searches its own database 120 it could likewise search (simultaneously or otherwise) the databases of the linked financial institutions and combine any located data in a response to a requester.

In some embodiments risk-related data (e.g., a risk score) may be generated based on the account data provided to and stored database system 110, and provided to a requester as described in conjunction with FIGS. 4 and 6 (step 430 or step 630). This is illustrated by the scoring model and process of FIG. 7, where the account data for any given account is provided to scoring logic 710. The scoring logic, which could be implemented within the database management system 130 or a separate processing system (not shown) within central account database system 110, may use a statistical or rules-based analysis (other forms of analysis, such as artificial neural networks, could also be used) to develop a score (examples of analysis used by scoring logic 710 will be given shortly). In some instances, the account data may not be sufficient to generate a score (e.g., the account has recently been opened, or there has been very little or no account activity). In such case, the account data may be stored in a hold account queue 712 until sufficient data is available. In other cases, where there is sufficient data, the account data and resulting risk score may be stored in a scored account queue 714, which includes a risk score table 720.

The process of FIG. 7 also illustrates that the scoring process may be continuous. As additional new account data arrives for any accounts represented in the hold account queue 712, the account data is reapplied to the scoring logic 710. The additional data is also used in association with already scored accounts in scored account queue 714 to make fresh calculations of risk data for those accounts. That is, the scoring logic 710 is periodically re-run using updated account data (along with previous data in the scored account queue 714), and the table 720 is updated with new scores as they are generated. Over time, most of the accounts represented in the hold account queue 712 should migrate to the scored account queue 714. Eventually, most active accounts will have risk scores in table 720.

In FIG. 7, risk scores 722 in table 720 are illustrated as numerical (from 1 to 100), with “100” representing the highest risk and “1” representing the lowest. Of course other, simpler forms of risk data could be generated, such as only three risk levels (“low,” “medium,” and “high”). Also, risk reasons 724 are illustrated in table 720. Such reasons (or codes for such reasons) could be based on risk factors described below.

The following tables illustrate scoring analysis (exemplary risk factors and corresponding risk impact) that could be used in scoring logic 710, for both an account search request (involving government benefits) and an asset verification request (involving a mortgage application). In one embodiment, the risk scores could be calculated by initially assigning a neutral score (e.g., 50), and then increasing or decreasing the initial score based on the risk impact identified in the tables. Also, individual risk factors could be weighted differently, e.g., depending on desires of the requester or based on experiential data collected by the operator of the system 110. Further, some risk factors require comparing account data to relevant data in separate, external databases (as an example, such databases might store names, addresses, email addresses, phone numbers and account numbers of suspected fraudsters). The system 110 would access those external databases as necessary in performing various risk analysis steps.

Risk Score Analysis
Account Search -Government Benefits

| Factors | Risk Impact |
|---|---|
| Transfer In/Out Patterns | Frequent deposits and withdrawals - |
| (money flow in and | increased risk (likely attempt to keep |
| out of account) | balances low) |
| | Infrequent transactions - decreased risk |
| Dates of Withdrawals (in | Withdrawals within 6 months of begin |
| relation to program | date - increased risk (likely attempt to |
| requirements specifying a | conceal assets) |
| begin date for balances to | Withdrawals more than 6 months prior |
| be below program threshold | to begin date - decreased risk |
| amount) | |
| Amount of Withdrawals | At least one withdrawal - increased risk |
| (e.g. total withdrawals of | |
| $1000 during past 5 years) | No withdrawals - decreased risk |
| Number/Nature of Located | 5 or more located accounts (likely attempt |
| Accounts | to spread assets)- increased risk |
| | Less than 5 located accounts - decreased |
| | risk |
| | Accounts located but not identified by |
| | beneficiary - increased risk |
| Names, addresses, phone | Matches with suspected fraudsters - |
| numbers on account (in | increased risk |
| addition to those of | No matches with suspected fraudsters - |
| beneficiary) | decreased risk |
| Account SSN/Name Match | SSN or name for account do not match |
| | those provided in request - increased risk |
| | Both SSN and name for account match |
| | those provided in request - decreased risk |

Risk Score Analysis
Asset/Account Balance Verification - Mortgage Application

| Factors | Risk Impact |
|---|---|
| Saving Pattern | Infrequent deposits during each month (not a likely |
| | consistent “saver”) - increased risk |
| | Frequent and consistent deposits - decreased risk |
| Added Signer | Signer address same as applicant - decreased risk |
| | Signer address at zip code distant from applicant - |
| | increased risk |
| | Name or SSN of new signer matches suspected |
| | fraudsters - increased risk |
| | No matches with suspected fraudsters - decreased |
| | risk |
| Recent deposits | Large Amount(s) - increased risk |
| | Small amount(s) - decreased risk |

Also, because the system 110 will likely store account information across most (if not all) financial institutions, additional data (not directly related to the account at hand) can be collected to provide additional forms of risk analysis. For example, if account data for an account is accessed and it reveals a large deposit (or a series of recent deposits that total a large amount), all other accounts in the system could be checked to see if a corresponding and identical withdrawal amount (or series of withdrawals) can be matched, thus linking another account (as a source account) to the account at hand. The system 110 could then check external databases to see if the source account is associated with a fraudster.

Embodiments of the invention also support other useful ways to tap the extensive and rich source of information maintained in the system 110. For example, the account data (including the risk scores) maintained in the system 110 may be used to assess creditworthiness. Not only could stored risk data be used in such an assessment, but loan or other credit accounts could be accessed (e.g., using only a SSN) to locate outstanding balances or credit limits (when stored in association with such accounts), and thus determine either the general creditworthiness of a person or entity (e.g., a person applying additional credit), but also verify representations made by an applicant in connection with the applicant's existing accounts.

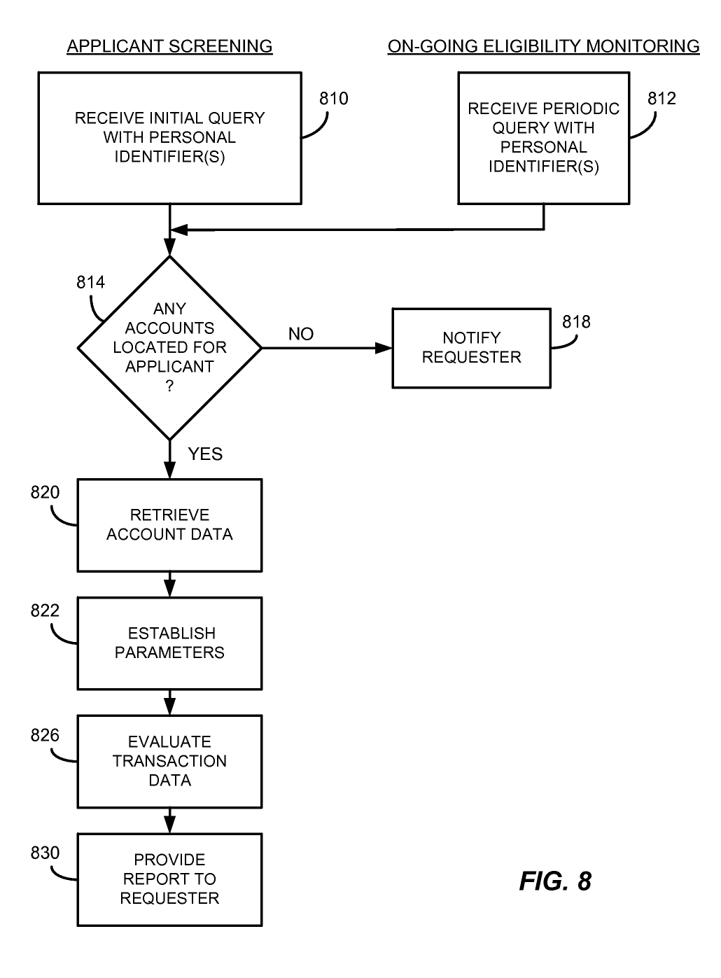

In some embodiments of the invention, account data located at the database system 110 may be used to identify or verify income for an account holder. A process implemented at database system 110 for such purpose is illustrated in FIG. 8.

The process begins with a query from a requesting entity. In one embodiment, the requesting party could be a government agency that administers unemployment income benefits, wanting to verify that an applicant has no employment income. In another embodiment, the requesting party could be a mortgage company or other entity wanting to verify income provided by an applicant (e.g., to confirm income stated on a mortgage loan application). These are only two examples and there are, of course, many other possible situations where a requesting party may want to identify or verify income. The query could either be as part of the initial screening of an applicant (block 810) or as part of on-going periodic monitoring of accounts for changes in income (block 812). An example of ongoing monitoring would be a mortgage company wanting to monitor accounts of an applicant to determine when income has changed (e.g., an applicant has become unemployed or has had a reduction in pay). In both cases, the overall process for verifying income may involve the same or similar steps following the query steps 810, 812. In each case, the query received from the requesting entity would include personal data identifying the applicant.

For example, in an initial applicant screening at step 810, the requester could send the applicant's name, address, social security number, and one or more account numbers, e.g., account numbers provided by the applicant (either alone or jointly with others). The initial query could be real-time or near-real-time, with data entered by the requester and a real-time response returned indicating (as will be described) whether there is income likely received at the located accounts (and perhaps a score indicating the degree of likelihood that a deposit is in fact income). Alternatively, the query could be made in batch-mode, say at the end of each day, reflecting all loan applications received that day, with results returned for all those applications.

In the case of on-going verification at step 812, the requester could send personal data concerning one or more applicants. In one embodiment, queries at step 812 would be sent at regular intervals in batch mode with files for a group of some or all current applicants, updated to reflect any changes to information for individual applicants (such as new account numbers) and also including new applicants that have been added since the last query and deleting applicants whose loans have been approved/denied since the last query. Alternatively, the query at step 812 could be in real-time for a single, current applicant whose loan application is pending.

Using the personal data or information in the query, accounts are located at step 814. Accounts may be located by account numbers given in the query. Alternatively, the claimant's social security number, name, or address could be used to also locate accounts that might be present in database 120, in a manner similar to that described in conjunction with FIGS. 4 and 5.

If no accounts are located, the requester is notified at step 818. In the case of an initial screening, such a circumstance might require follow-up with the applicant to make sure correct account information was given. In some embodiments, the absence of a located account might be used to indicate risk associated with the application (e.g., a perceived higher risk if the applicant appears to have provided false information). Similarly, if an applicant gives an account number and other personal information (name, social security number, etc.) found in database system 110 and the located account does not match the applicant, a risk score assigned to that applicant might also be increased. In some embodiments, if step 814 identifies a large number of accounts owned by the applicant, such fact in and of itself might be a factor that would increase risk (fraudsters often set up and access many accounts in order to conceal fraudulent activity).

If accounts are located at step 814, then account data for those accounts are retrieved from database system 110, step 820, for subsequent analysis.

In one embodiment as described earlier, the database system 110 consists of two separate databases rather than the illustrated single account database 120 (FIG. 1). In such case, step 814 is accomplished by accessing a first database storing account information contributed by a large number of institutions (as illustrated, e.g., in FIG. 2) . In response to the personal identifier in the query (step 810 or step 812), the first database is accessed and any account number stored in relation to the personal identifier is retrieved and provided, at step 814. A second database stores transaction data (such as ACH transactions) posted to accounts maintained at a large number of institutions (such as the same institutions for which account information is collected for the first database). At step 820, transaction data relating to account numbers identified at step 814 is retrieved from the second database.

The use of two databases within database system 110 as just described provides advantages in efficiency and operation of the system 110 when performing an income identification/verification process, such as that illustrated in FIG. 8. As described earlier, data relating to each account and its account holder or owner (for storage and retrieval from the first database) comes from many institutions. While such account data is updated frequently to reflect changes to accounts and the creation of new accounts, storing transaction data in the same database would significantly increase the amount and complexity of data being stored in a single database device, and may not be needed for all queries (e.g., those not related to verifying income). Accordingly, with non-transaction account data stored in the first database, such database can be quickly accessed at step 814 to locate account numbers (if needed) and notify a requester if no accounts have been located at step 818. The use of the second database at step 820 for storing large amounts of transaction data (data for potentially many transactions posted at many accounts at many institutions), permits more efficient searching for account numbers (in the first database) and more efficient searching through vast amounts of transaction data (in the second database).

At step 822, parameters are established/retreived for review of account data, such as the transaction data retrieved at step 820. The parameters could depend on the nature of the query (e.g., initial screening vs. on-going verification). The parameters could also depend on the desires of the requester. For example, in the case of an initial screening, the time window might be established for transactions within six month period prior to a loan application. In the case of on-going verification, the time window for which the transactions are to be reviewed could be, e.g., the period of time since the date of the loan application.

Transaction data is then evaluated at system 110, step 826. Such evaluation could be done, for example, for ACH and non-ACH transactions as described earlier in conjunction with FIG. 3.

The results reflect likely income (amounts, period of time over which likely income was posted, and income type) and would be provided to the requester at step 830, e.g., in the form of an electronically communicated report. In addition, since there may be some ambiguity as to whether deposits/credits reflect actual income, a score reflecting the likelihood that reported income is in fact actual income could also be provided at step 830. Further, a score relating to the predictability of the income continuing for some period of time in to the future (based on the nature of the transactions) could be provided. Finally, if there are any risk factors relating to fraud associated with the applicant's account, that could also be provided in the report at step 830.

In some embodiments, a requester, such as a bank seeking to verify income for a loan applicant), may want to reduce the transmission of personal identifiers between itself and the system 110. This can be accomplished, for example, by the requester providing a request reference number along with a personal identifier (step 810 or step 812). When a response is received, such as the requester being notified that no accounts have been located (step 818) or a report of income and probability/risk scores (step 830), the response provides the request reference number along with reported results, but without returning personal identifiers originally provided by the requester.

In one alternative embodiment, the query at step 810 may be from an agency at which the applicant has applied (or made a claim) for unemployment insurance (UI) benefits, and that agency is making a request to determine the likelihood of employment income (in the form of deposit/credits) posted to an account and that would disqualify the applicant/claimant from receiving such benefits. The following Table I illustrates for such embodiment a simplified and high-level risk score model, with only one of four risk scores (Risk Scores 1-4) given for each claimant, based on six different combinations of various risk criteria/factors (Risk Criteria A-F).

TABLE I

| | Risk | Risk | Risk | Risk | Risk | Risk |
|---|---|---|---|---|---|---|
| | Criteria A | Criteria B | Criteria C | Criteria D | Criteria E | Criteria F |
| | Name, SSN, | Type of | UI Deposit & Payroll | UI Deposit & Recurring | Payroll deposit | Recurring other |
| | ABA Routing | Account | Deposit in the | other deposit in the | found in a separate | deposit found in a |
| Risk | Number, | (Individual | same time period | same time period | account in the same | separate account in |
| Score | and Account | Joint or | to the same | to the same | time period with | the same time period |
| Category | Number Match | Unknown) | account | account | the same owner | with same owner |
| 1 | Yes | Individual | Yes | No | Yes | No |
| 2 | Yes | Individual | No | Yes | No | Yes |
| 3 | Yes | Joint/Unk | Yes | No | Yes | No |
| 4 | Yes | Joint/Unk | No | Yes | No | Yes |

In this embodiment, Risk Score 1 represents the highest risk of there being disqualifying income for a claimant. In this category, the name, social security number (SSN), routing number and account number given in a query are found to match data in the database 120 (Risk Criteria A). The Type of Account (in which a relevant transaction with risk has been found) is an individual account (Risk Category B). Risk Criteria C or E also are found, i.e., either a UI deposit and payroll deposit are found in the same period in the same account (Risk Criteria C), or the payroll (employment) deposit is found in the same period in a different account (not the account where the UI deposit is made) that is owned by the claimant (Risk Criteria E).

Risk Score 2 is a lower risk than Risk Score 1, and in this category the name, social security number (SSN), routing number and account number are found to match data in the database (Risk Criteria A). The Type of Account is an individual account (Risk Category B). Risk Criteria D or F are also found, i.e., either the UI deposit and a recurring deposit are found in the same period in the same account (Risk Criteria D) or a recurring deposit is found in the same period in a different account owned by the claimant (Risk Criteria F). This risk is lower because a recurring deposit may (or may not) reflect employment income, and thus the likelihood of fraud is deemed lower in the scoring model.

Risk Score 3 is a lower risk than Risk Score 2, and the criteria found are similar to Risk Score 1, except that the type of account located is a joint account co-owned by the claimant, rather than an individual account (or the individual/joint feature is unknown). This risk is lower because a payroll deposit in a joint account may be attributable to the co-owner, and thus the likelihood of fraud is deemed lower.

Risk Score 4 is a lower risk than Risk Score 3, and the criteria found are similar to Risk Score 2, except that the type of account located is a joint account co-owned by the claimant rather than an individual account. This risk is lower because a recurring deposit in a joint account may not be employment income, and the recurring deposit may be attributable to the co-owner, and thus the likelihood of fraud is lower.

As should be understood, the forgoing is only a simple example of a risk score arrangement, and many other scoring models are possible, e.g., models involving more sophisticated analyses, more (or different) risk criteria including any of the applicant's identity information or parameters, and courser or finer granularity of levels of risk scores.

In some embodiments, risk can be analyzed and scored using data other than deposit transactions posted to a claimant account. In some cases, all types of transactions might be reviewed, including those reflecting expenditures or payments out of the account. As an example, transaction payments out of the account to persons or entities associated with fraud or other suspicious activity might increase a risk score. In addition, while the described embodiments primarily discuss the review of transactions posted to checking accounts (or demand deposit accounts “DDA”), many other types of accounts at the institutions 140 can be accessed in evaluating risk, such as savings accounts, debit card accounts, brokerage and investment accounts, stored value accounts, and money transfer accounts, information from payroll processing services, payroll data aggregators, payroll payment providers, military benefits administrators, state or federal governmental taxing authorities such as the Internal Revenue Service, or any other desired data source comprising income-related information . These other types of accounts may be used individually or in combination with each other and/or checking/DDA accounts.

As a further aspect of the present invention, a government or law enforcement agency may provide one or more personal identifier(s) corresponding to an individual or an entity named in a subpoena (or an instrument such as a National Security Letter or Writ of Execution) for financial or accounting records access, and the provided personal identifier(s) is/are used to determine which institutions, if any, have account or financial information for the individual or an entity named in the subpoena. If one or more of such institutions are found to have such account or financial information for the individual or an entity named in the subpoena, the names of the matching institutions are provided to the government or law enforcement agency with sufficient information (account number or identification information, for example) so that the subpoena may be efficiently served on the one or more matching institutions. If no matching institutions are found, indicia showing no match found may be returned to the government or law enforcement agency. As described more completely below, additional embodiments may perform analysis to provide additional information to the querying agency. The personal identifier for the individual or entity named in the subpoena may comprise any desired identification element, including, but not limited to, an SSN, a personal name, a mailing address, a physical address, the name of a corporate entity, a driver's license number, a prisoner number, an immigration number, a Matricula Consular number, or any other desired indicia. Further, personal identifiers may constitute a plurality of information designed to either narrow or broaden the search criteria depending on the desired result. Requiring more than one match for a plurality of provided identifiers might produce fewer results and would narrow the search. A match for any one of a plurality of provided identifiers might produce more results and would broaden the search.

For example, furnishing a plurality of personal identifiers such as an SSN and name and address (and requiring that an identified account have a match for each of the SSN, name and address) may further refine the search results and limit false positives, but depending on the amount of information returned, submissions of multiple identifiers, if a multiple match is required, could return too little information to be useful. Optionally, and to further refine results, the submitting agency may specify which of the submitted personal identifiers are required, and which may be optional, or which may be required in combination. For example, the submitting agency may specify that both a last name and an SSN must match the submission. In some embodiments, personal identifiers may comprise a list of related information for a suspect individual, for instance, a list of personal identifiers corresponding to known associates of the individual, and accounts of the known associates may be identified (along with the accounts of the suspect individual). Using additional analysis techniques, which may include link analysis or network analysis, account information corresponding to known associates and to others linked to the individual or entity identified in the subpoena may be returned to the submitting agency.

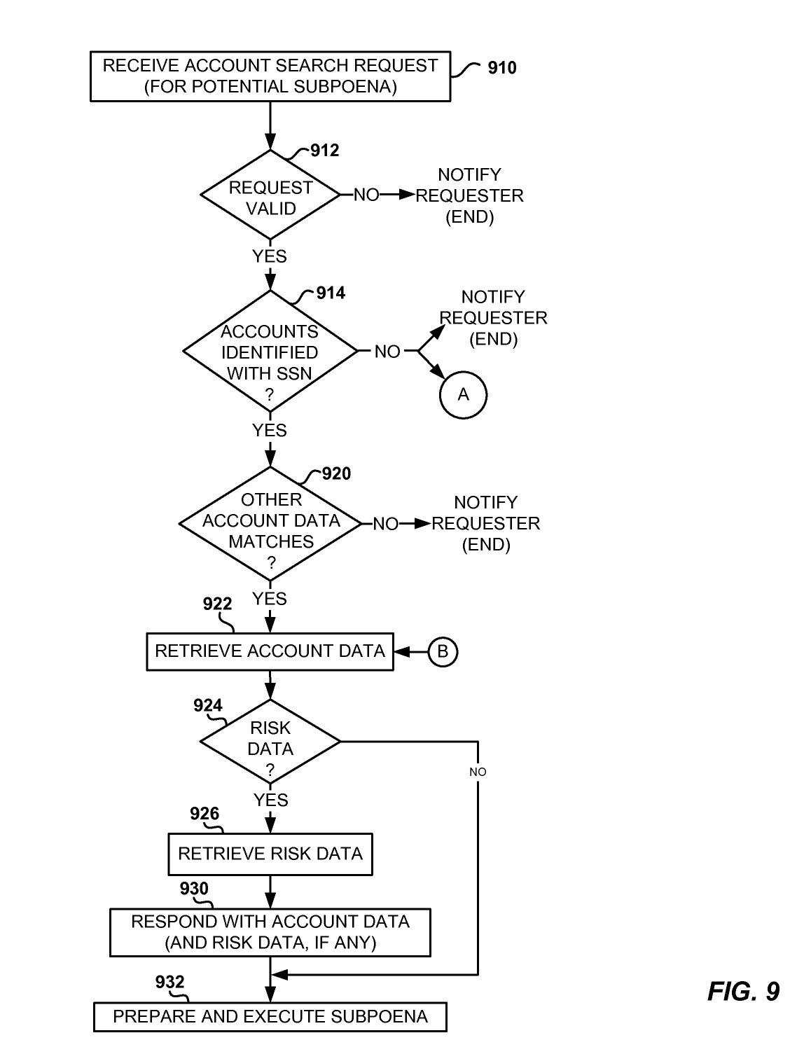

A simplified illustration of one such process is seen in FIG. 9. The process of FIG. 9 is similar to (and has steps corresponding to those of) of FIG. 4, but more specifically involves a search request (step 910) from a government agency for an individual or entity contemplated as the subject of a subpoena. As described in conjunction with FIG. 4, the system 110 determines whether the request is valid, step 912, and whether any accounts associated with a personal identifier of the subject (such as a social security number) can be identified, step 914. If there is no SSN match, then the requester is notified (and the process may end), but optionally, other steps can be undertaken to identify accounts without using a social security number (steps proceeding from point “A” in the drawings, using a process similar to that described earlier in conjunction with FIGS. 4 and 5). At step 920 other account data (e.g., name and address, if any, provided with the request) may be used to provide additional confirmation that the identified account is matched to the person that is the subject of the search. While not illustrated in FIG. 9, linking and network analysis can optionally be used to identify additional accounts and provide other information that may have some association with the subject of the contemplated subpoena, as will be described in connection with a specific example to follow shortly. Account data for any identified account is retrieved at step 922. As in FIG. 4, if risk data associated with an identified account is available (step 924), it may also be retrieved (step 926). Among other things, risk data may be used to determine the need for quickly executing a subpoena and then seizing an account that has a high risk of being involved in fraudulent activity (and that may be likely to have its balance quickly depleted/transferred by the fraudster/account holder). The retrieved data is provided (step 930), and a subpoena is prepared and executed at step 932 by the government agency.

As a specific example addressing an embodiment of the present invention, consider a hypothetical subpoena that is planned to be issued so that a law enforcement agency may find and obtain financial account information (and possibly related information) for an individual named Vito A. Corleone who has an SSN of 123-45-6789. Prior to embodiments of the present invention being available, difficulties immediately arise in trying to determine which financial institutions may have accounts for Vito Corleone; prior practices may have involved serving subpoenas or NSLs on a large number of financial institutions hoping that one or more of them have an account for Vito Corleone. In the process, much time and expense was wasted serving the subpoenas or NSLs to the institutions not having accounts for Vito, as well as the wasted time and expense borne by the financial accounts in responding to such “blind guess” subpoenas. However, in embodiments of the present invention, the law enforcement agencies may be provided indicia regarding which institutions have accounts related to Vito Corleone with a matching SSN, and optionally, account identifying information corresponding to accounts for which Vito is a signatory.

In a modification of the previous example, consider the case where no hits were found for Vito Corleone, with or without his SSN, at any institution's records stored in the database system 110 of the present invention. It may be likely that accounts may have been opened at various institutions by Vito's known associates to attempt to conceal Vito's financial transaction information. In an embodiment of the present invention, Vito's last known address was known by the submitting law enforcement agency (123 Genco Way, Long Island N.Y.), and a list of known associates: P. Clemenza, S. Tessio, L. Brasi, D. Tommasino, and T. Hagen. A query could then be submitted to systems of the present invention to find accounts matching his address and any of his known associates, and such accounts may then be scrutinized to determine whether they are associated with Vito Corleone. Those of skill in the relevant arts also realize that other cross-matching information (for example Vito's middle name “Andolini”) might be utilized with or without his SSN, and with or without other identifying information such as known associates. Further, through analyzing a network of Vito's associations created through linking and network analysis techniques as more completely described in U.S. Provisional Patent Application No. 61/448,156 filed Mar. 1, 2011 entitled, “System and Method for Suspect Entity Detection and Mitigation,” the disclosure of which is hereby fully incorporated by reference for all purposes, ancillary information regarding Vito Corleone's social or financial transaction history may be analyzed to determine possible accounts that have some association with Vito. Types of ancillary information provided about Vito may include checking account records of any kind (bank statements, cancelled checks, etc.), loan information (loan applications, ledgers, etc.), savings account and securities records (certificates of deposit, investments, etc.), records of any safe deposit boxes at a bank, supporting financial documents (copies of tax returns, credit reports, etc.), current or present addresses associated with an account, hot files, accounts closed for cause, mobile or land line phone numbers associated with Vito or his present or prior addresses, and the like. Once a network has been constructed with Vito's identifying information, related accounts (or other information) and the institutions that host them, may be provided to the querying law enforcement agency.

Submissions of requests for subpoena/NSL account identification may be made by the requesting agency individually in a real-time, or in a single or grouped batch mode submittal that is executed at a predetermined time interval (for example, overnight). Additionally, further analysis could produce information that may be provided to the requesting government or law enforcement agency regarding identity information for other individual signatories on joint accounts that correspond to the individual or entity named in the subpoena; prior transactions indicating financial fraud related to the individual or entity named in the subpoena, and through network analysis, identifications of or risk indicia regarding any potential fraud rings associated with the individual or entity that is named in the subpoena. As such, additional related investigatory leads may be provided to the government or law enforcement agency as a result of social or transactional associations with other entities. In an additional aspect, the requesting agency (or an entity, broker, or processor acting on the agency's behalf), after determining which institutions possess information about the subject of the subpoena/NSL, may send to the relevant institutions a formatted request for information that allows the possessing institutions to “fill in the blanks” for any missing data that is pertinent to the subject of the subpoena/NSL, and the requesting entity/broker/processor may process the response on the institution's behalf directly to the law enforcement agency. In a further aspect of the present invention, the requesting government agency may specify to a processor/broker the relevant laws, statutes, rules, or orders under which it has acting authority to submit the subpoena/NSL, and the processor/broker pursues obtaining the information for the agency on its behalf Further, the processor/broker may utilize the specified listing of laws, statutes, rules or orders furnished by the government agency to tailor the information request to one or more institutions that have been determined to possess information about the subject of the subpoena/NSL, and may optionally filter or redact any information that is received from the relevant institutions that is not permitted to be provided under a legal framework of identified statutes, laws, or rules.

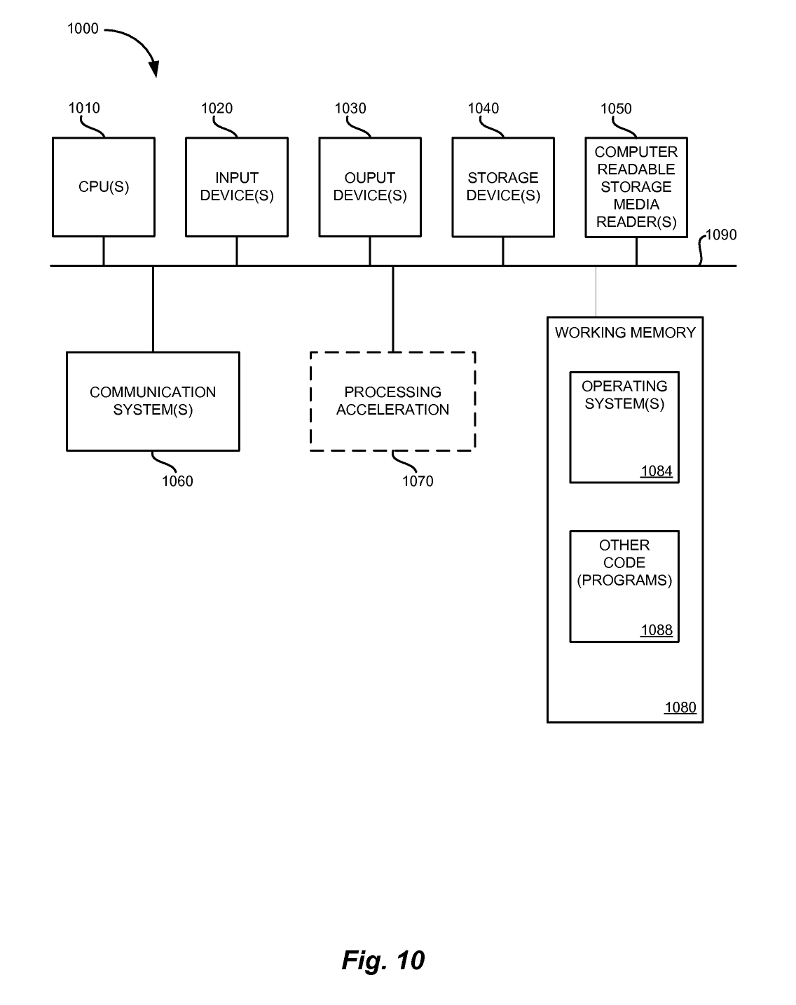

FIG. 10 is a block diagram illustrating an exemplary computer system upon which embodiments of the present invention may be implemented. This example illustrates a computer system 1000 such as may be used, in whole, in part, or with various modifications, to provide the functions of the central database system 110, including the DBMS 130 and the scoring logic 710, as well as other components and functions of the invention described herein.

The computer system 1000 is shown comprising hardware elements that may be electrically coupled via a bus 1090. The hardware elements may include one or more central processing units 1010, one or more input devices 1020 (e.g., a mouse, a keyboard, etc.), and one or more output devices 1030 (e.g., a display device, a printer, etc.). The computer system 1000 may also include one or more storage devices 1040, representing remote, local, fixed, and/or removable storage devices and storage media for temporarily and/or more permanently containing computer-readable information, and one or more storage media reader(s) 1050 for accessing the storage device(s) 1040. By way of example, storage device(s) 1040 may be disk drives, optical storage devices, solid-state storage device such as a random access memory (“RAM”) and/or a read-only memory (“ROM”), which can be programmable, flash-updateable or the like.

The computer system 1000 may additionally include a communications system 1060 (e.g., a modem, a network card—wireless or wired, an infra-red communication device, a Bluetooth™ device, a near field communications (NFC) device, a cellular communication device, etc.) The communications system 1060 may permit data to be exchanged with a network, system, computer, mobile device and/or other component as described earlier. The system 1000 also includes working memory 1080, which may include RAM and ROM devices as described above. In some embodiments, the computer system 1000 may also include a processing acceleration unit 1070, which can include a digital signal processor, a special-purpose processor and/or the like.

The computer system 1000 may also comprise software elements, shown as being located within a working memory 1080, including an operating system 1084 and/or other code 1088. Software code 1088 may be used for implementing functions of various elements of the architecture as described herein. For example, software stored on and/or executed by a computer system, such as system 1000, can be used in implementing the processes seen in FIGS. 4-9.

It should be appreciated that alternative embodiments of a computer system 1000 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the central account database system 110 system may be implemented by a single system having one or more storage device and processing elements. As another example, the central account database system 110 system may be implemented by plural systems, with their respective functions distributed across different systems either in one location or across a plurality of linked locations.

Moreover, while the various flows and processes described herein (e.g., those illustrated in FIG. 4-9) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A report reflecting income to an account holder, comprising:
an request identifier associated with a request for the report;
account identifying information pertaining to at least one account of the account holder; and
income information pertaining to a period of time generated from transaction information associated with the at least one account;
wherein the at least one account is associated with the account holder by evaluating an account owner database, the account owner database storing account identifying information associated with a plurality of accounts and personal identifying information relating to the account holder of each of the plurality of accounts;
wherein the at least one account is evaluated for transactions posted to that account by accessing an ACH database in response to the account identifying information, the ACH database storing data pertaining to ACH transactions posted to the plurality of accounts, with the income information determined from ACH transactions posted to the at least one account and relating to be deposits that reflect possible periodic income of the account holder.

2. The report of claim 1, wherein the plurality of accounts having account identifying information stored in the account ownership database are associated with a plurality of financial institutions.

3. The report of claim 1, wherein the ACH transactions relating to deposits reflecting possible periodic income comprises a plurality of ACH transactions posted over the period of time.

4. The system of claim 3, wherein the plurality ACH transaction are ACH credit transactions.

5. The report of claim 3, wherein the plurality of ACH transactions are evaluated to determine a pattern of income.

6. The report of claim 1, wherein the income information determined for ACH transactions is based on evaluation of at least one of an originator field, a standard entry class field, and an originator entry description field in an ACH transaction message associated with ACH transactions posted to the at least one account.

7. The report of claim 1, wherein the account identifying information pertaining to the at least one account comprises an account identifier.

8. The report of claim 1, wherein the account identifier comprises an account number.

9. The report of claim 1, wherein the report further comprises a score indicating the probability that the income information in the report relates to actual income.

10. The report of claim 1, wherein the report further comprises a risk score reflecting the likelihood of fraud associated with the at least one account.

11. The report of claim 1, wherein the request for the report is provided in response to a loan application by the account holder, for purposes of verifying income stated by the account holder in the loan application.

12. The report of claim 1, wherein the loan application is an application for a mortgage loan, consumer loan, or credit card.

13. A system for providing a requested income profile to a requester based on a personal identifier for a subject for which the income profile is requested, the system comprising:
a first database that stores account identifiers associated with each of a plurality of accounts, wherein an account identifier for at least one of the accounts is retrieved in response to the personal identifier for the subject; and
a second database that stores ACH transaction information that has been posted to the plurality of accounts, wherein upon receipt of an account identifier retrieved from the first database, ACH transaction information posted to the at least one of the accounts is retrieved from the second database, the ACH transaction information evaluated to identify periodic income for the subject over a period of time, with the income profile comprising a request identifier provided by the requester, identified periodic income for the subject from the evaluated ACH transaction information, and the account identifier for the at least one of the accounts.

14. The system of claim 13, wherein the plurality of accounts having account identifiers stored in the first database are associated with a plurality of financial institutions.

15. The system of claim 13, wherein the ACH transaction information evaluated to identify periodic income comprises a plurality of ACH transactions posted over the period of time.

16. The system of claim 15, wherein the plurality of ACH transactions are ACH credit transactions.

17. The system of claim 15, wherein the plurality of ACH transactions are evaluated to determine a pattern of income.

18. The system of claim 13, wherein the income information determined for ACH transactions is based on evaluation of at least one of an originator field, a standard entry class field, and an originator entry description field in an ACH transaction message associated with ACH transactions posted to the at least one account.

19. The system of claim 13, wherein the personal identifier for the subject comprises one or more of a social security number, name, physical address, email address, phone number, and date of birth.

20. The system of claim 13, wherein the account identifier comprises an account number.

21. The system of claim 13, wherein the income profile further comprises a score indicating the probability that the identified periodic income is actual income.

22. The system of claim 13, wherein the income profile further comprises a risk score reflecting the likelihood of fraud associated with the at least one account.

23. The system of claim 13, wherein the income profile is requested by the requester in response to a loan application by the subject, for purposes of verifying income stated by the subject in the loan application.

24. The system of claim 13, wherein the loan application is an application for a mortgage loan, consumer loan, or credit card.
